(19) United States
(12) Patent Application Publication
(10) Pub. No.: US 2026/0216968 A1
(43) Pub. Date: Jul. 30, 2026

(54) FORMING A COMPOSITE STRUCTURE USING PRE-KITTED PLY SETS

(71) Applicant: The Boeing Company, Arlington, VA (US)

(72) Inventor: Phillip John Crothers, Hampton East (AU)

(21) Appl. No.: 19/036,740

(22) Filed: Jan. 24, 2025

(51) Int. Cl. B29C 70/30; B29C 70/54; B29L 31/30

(52) U.S. Cl. CPC B29C 70/304; B29C 70/543; B29L 2031/3076

(57) ABSTRACT

A composite structure and methods of forming a composite structure are presented. The composite structure comprises a plurality of pre-kitted ply sets with a same ply layup positioned to form continuous plies. Each pre-kitted ply set of the plurality of pre-kitted ply sets comprises a first ply having a first shape and an overhang on a first side of the ply layup; and a second ply overlying the first ply, the second ply having a second shape.

### BACKGROUND INFORMATION

### 1. Field

The present disclosure relates generally to composite manufacturing and more specifically to laying up composite plies to form a composite prepreg layup.

### 2.Background

Thermoplastic structures have been limited in application to large scale structures due to the recurring cost of materials, the non-recurring cost of large-scale processing infrastructure, and the lower deposition rates of thermoplastic materials lead to a multiplication of the infrastructure and tooling.

Therefore, it would be desirable to have a method and apparatus that takes into account at least some of the issues discussed above, as well as other possible issues. For example, it would be desirable to lower costs of manufacturing large thermoplastic structures. Additionally, it would be desirable to increase the rate of manufacturing large thermoplastic structures.

### SUMMARY

An embodiment of the present disclosure provides a composite structure. The composite structure comprises a plurality of pre-kitted ply sets with a same ply layup positioned to form continuous plies. Each pre-kitted ply set of the plurality of pre-kitted ply sets comprises a first ply having a first shape and an overhang on a first side of the ply layup; and a second ply overlying the first ply, the second ply having a second shape.

Another embodiment of the present disclosure provides a method of forming a composite structure. A first pre-kitted ply set is laid onto a tool. The first pre-kitted ply set comprises a ply layup comprising a first ply having a first shape and an overhang on a first side of the ply layup and a second ply overlying the first ply, the second ply having a second shape. A second pre-kitted ply set is laid onto the tool abutting the first pre-kitted ply set to form continuous plies. The second pre-kitted ply set comprises the ply layup, wherein a first ply of the second pre-kitted ply set abuts the first ply of the first pre-kitted ply set and a second ply of the second pre-kitted ply set abuts the second ply of the first pre-kitted ply set.

Yet another embodiment of the present disclosure provides a method of forming a composite structure. A plurality of pre-kitted ply sets is laid up with a same ply layup to form continuous plies. Each pre-kitted ply set of the plurality of pre-kitted ply sets comprises a first ply having a first shape and an overhang on a first side of the ply layup, and a second ply overlying the first ply, the second ply having a second shape.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIGS. 2A and 2B are an illustration of a block diagram of a manufacturing environment in accordance with an illustrative embodiment;

FIG. 3 is an illustration of a top view of a pre-kitted ply set in accordance with an illustrative embodiment;

FIG. 4 is an illustration of a top view of a plurality of pre-kitted ply sets in accordance with an illustrative embodiment;

FIG. 5 is an illustration of a top view of a plurality of pre-kitted ply sets in accordance with an illustrative embodiment;

FIG. 6 is an illustration of a top view of a pre-kitted ply end set in accordance with an illustrative embodiment;

FIG. 7 is an illustration of a top view of a plurality of pre-kitted ply sets and a pre-kitted ply end set in accordance with an illustrative embodiment;

FIG. 8 is an illustration of a top view of a plurality of pre-kitted ply sets and a second plurality of pre-kitted ply sets in accordance with an illustrative embodiment;

FIG. 9 is an illustration of a top view of a pre-kitted ply set in accordance with an illustrative embodiment;

FIG. 10 is an illustration of a top view of a plurality of pre-kitted ply sets in accordance with an illustrative embodiment;

FIGS. 11A and 11B are a flowchart of a method of forming a composite structure in accordance with an illustrative embodiment;

FIG. 12 is a flowchart of a method of forming a composite structure in accordance with an illustrative embodiment;

FIG. 13 is an illustration of an aircraft manufacturing and service method in a form of a block diagram in accordance with an illustrative embodiment; and

FIG. 14 is an illustration of an aircraft in a form of a block diagram in which an illustrative embodiment may be implemented.

### DETAILED DESCRIPTION

The illustrative examples recognize and take into account several considerations. The illustrative examples recognize and take into account that current thermoplastic processing techniques include preconsolidation of an entire thermoplastic stack, automated fiber placement (AFP), prepreg processing, and dry fiber processing. The illustrative examples recognize and take into account that pre-consolidation of an entire stack is typically done in a flat configuration to save tooling.

The illustrative examples recognize and take into account that automated fiber placement (AFP) is large scale, expensive, and slow. The illustrative examples recognize and take into account that in current thermoplastic processing, the entire thermoplastic stack is formed into a final shape. The illustrative examples recognize and take into account that large stack consolidation of thermoplastics uses undesirably high pressure.

The illustrative examples recognize and take into account that prepreg automation includes tracking and utilizing outlife times, an undesirably large autoclave, and time to cure. The illustrative examples recognize and take into account that dry fiber processing of thermoplastics using dry fiber automation can include undesirable aspects such as limp fabrics, fiber fray, and fiber bulk.

The illustrative examples recognize and take into account that compared to thermoset prepregs or dry fibers/fabrics, thermoplastic materials have greater stiffness. The illustrative examples recognize and take into account that thermoplastic materials do not have to be fully restrained over the entire surface. The illustrative examples recognize and take into account that thermoplastic materials have zero tack. The illustrative examples recognize and take into account that thermoplastic materials are easy to pick up and release with suction. The illustrative examples recognize and take into account that thermoplastic materials have neater edges enabling improved accuracy of alignment to placement tolerances and adjacent plies and inspection operations. The illustrative examples recognize and take into account that neater edges can improve pick and place deposition activities when building up larger ply stacks from preforms.

The illustrative examples present methods of building preformed and pre-consolidated packs of thermoplastic plies to enable feeder lines to the large scale part deposition and consolidation. The illustrative examples reduce the overall pressure and infrastructure for the final, full-scale part consolidation. The illustrative examples reducing the overall pressure for consolidation of the large thermoplastic structure may lead to the use of a mini-clave infrastructure, instead of full-scale autoclaves.

Further, by preforming of packs of lesser thickness with a smaller number of plies, the illustrative examples enable more robust forming of complex shapes when compared to forming of thicker and larger stacks of plies.

The use of thermoplastic prepreg materials such as tapes in the illustrative examples will also enable greater automation and efficiencies in the deposition activity.

The illustrative examples can reduce the final consolidation infrastructure and tooling by reducing the cycle time for deposition. The illustrative examples can reduce the consolidation time and tooling required. In some of the illustrative examples, there is no matched tooling for the final large thermoplastic structure and there is a reduced autoclave requirement.

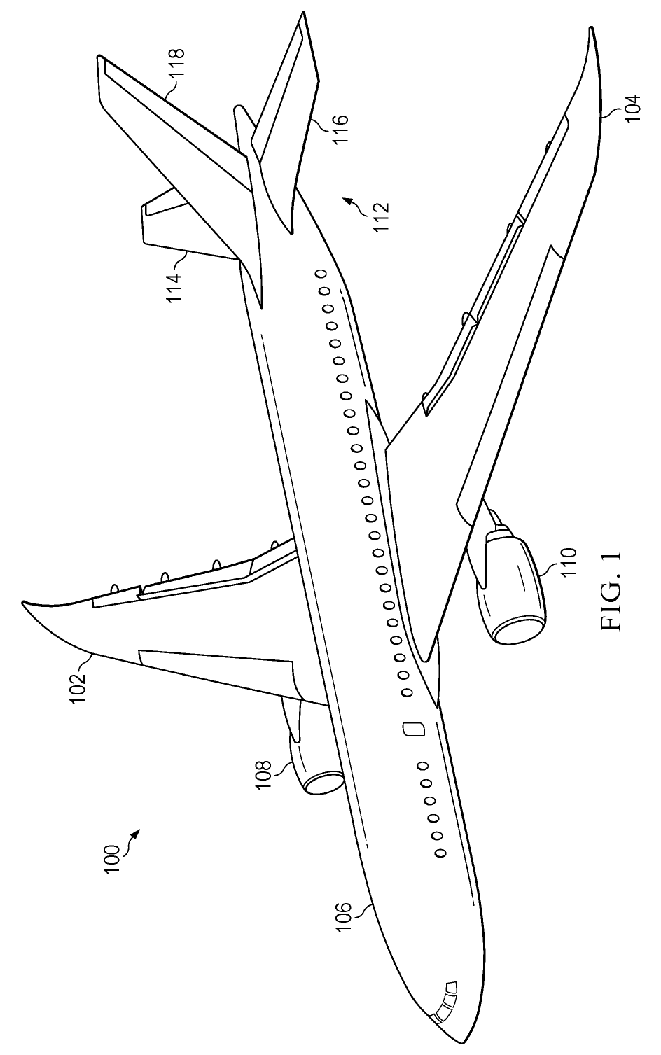

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114 , horizontal stabilizer 116, and vertical stabilizer 118 are attached to tail section 112 of body 106.

Aircraft 100 is an example of an aircraft that can have components manufactured using the illustrative examples. At least one of wing 102, wing 104, or body 106 can comprise portions manufactured using the illustrative examples.

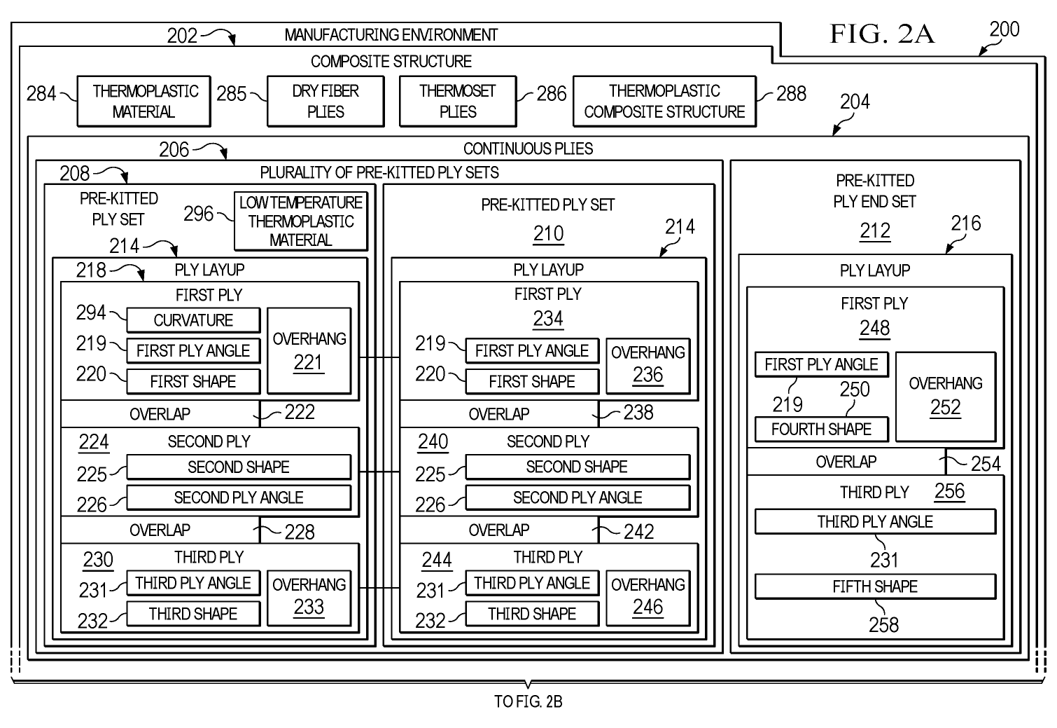

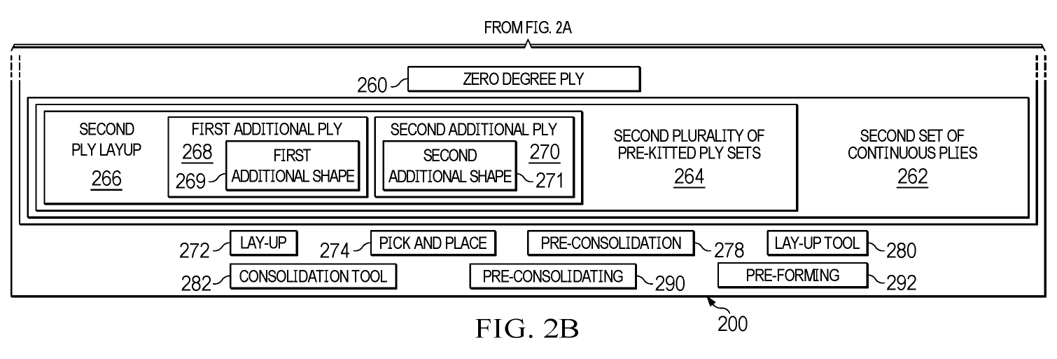

Turning now to FIGS. 2A and 2B, an illustration of a block diagram of a manufacturing environment is depicted in accordance with an illustrative embodiment. At least a portion of aircraft 100 of FIG. 1 can be manufactured according to the illustrative examples in manufacturing environment 200. Composite structure 202 comprising continuous plies 204 can be laid up in manufacturing environment 200 using plurality of pre-kitted ply sets 206. By abutting plurality of pre-kitted ply sets 206, continuous plies 204 of composite structure 202 are formed. Continuous plies 204 are layers of composite structure 202 formed by respective plies of pre-kitted ply sets positioned next to each other. In some illustrative examples, continuous plies 204 are also referred to as combined, aggregated, or merged. Continuous plies 204 may be referred to as aggregated plies.

In this illustrative example, continuous plies 204 comprises a first aggregated ply formed from first ply 218 and first ply 234. In this illustrative example, continuous plies 204 comprises a second aggregated ply formed from second ply 224 and second ply 240.

Plurality of pre-kitted ply sets 206 are each pre-consolidated prior to placement on consolidation tool 282. In some illustrative examples, plurality of pre-kitted ply sets 206 are each pre-formed on lay-up tool 280 prior to placement on consolidation tool 282. In some illustrative examples, lay-up tool 280 is an adaptive forming tool.

Using plurality of pre-kitted ply sets 206 allows prefabrication on a small scale (smaller scale infrastructure) to enable large scale part production and reduces the amount of monumental equipment. In some illustrative examples, plurality of pre-kitted ply sets 206 comprises small ply quantities to allow for prefabrication at lower pressures. In some illustrative examples, small ply quantities in plurality of pre-kitted ply sets 206 comprises pre-kitting no more than three plies. In some illustrative examples, small ply quantities in plurality of pre-kitted ply sets 206 comprises pre-kitting no more than four plies. Pre-kitting can comprise any desirable quantity of plies. In some illustrative examples, pre-kitting small ply quantities allows for easier forming.

Lay-up 272 generates plurality of pre-kitted ply sets 206. In some illustrative examples, lay-up 272 takes place on lay-up tool 280 having a desired curvature. In some illustrative examples, lay-up 272 takes place on a flat layup surface. After lay-up 272, plurality of pre-kitted ply sets 206 are pre-consolidated in pre-consolidation 278. In some illustrative examples, pick and place 274 lifts a respective pre-kitted ply set of plurality of pre-kitted ply sets 206 after lay-up 272. Pick and place 274 can lift a respective pre-kitted ply set from a layup surface and place the pre-kitted ply set on lay-up tool 280 for pre-forming. Pick and place 274 can lift a respective pre-kitted ply set from lay-up tool 280 after pre-forming.

As depicted, composite structure 202 comprises plurality of pre-kitted ply sets 206 with a same ply layup, ply layup 214, positioned to form continuous plies 204. Each pre-kitted ply set of plurality of pre-kitted ply sets 206 comprises a first ply having first shape 220 and an overhang on a first side of ply layup 214, and a second ply overlying the first ply, the second ply having second shape 225.

As depicted, plurality of pre-kitted ply sets 206 comprises pre-kitted ply set 208 and pre-kitted ply set 210. Pre-kitted ply set 208 comprises first ply 218 having first shape 220 and overhang 221 on a first side of ply layup 214. Pre-kitted ply set 208 comprises second ply 224 overlying first ply 218 and having second shape 225. First ply 218 has first ply angle 219. Second ply 224 has second ply angle 226. First ply 218 has first ply angle 219 different from second ply angle 226 of second ply 224. First ply angle 219 can be selected from any non-zero degree angle. In some illustrative examples, first ply angle 219 is selected from at least one of 30 degrees, +45 degrees, 60 degrees, -45 degrees, or 90 degrees.

First shape 220 can take any desirable form. In some illustrative examples, first shape 220 is a parallelogram. Second shape 225 can take any desirable form. In some illustrative examples, second shape 225 is a square.

In this illustrative example, second shape 225 has a portion overlapping a portion of first shape 220 within each pre-kitted ply set of plurality of pre-kitted ply sets 206. In this illustrative example, second ply 224 has overlap 222 over first ply 218.

In some illustrative examples, each pre-kitted ply set further comprises a third ply overlying the second ply, the third ply having third shape 232 and an overhang on a second side of ply layup 214. In this illustrative example, pre-kitted ply set 208 comprises third ply 230 overlying second ply 224. Third ply 230 comprises third shape 232 and has third ply angle 231. A portion of third ply 230 extends over second ply 224 to form overhang 233. In some illustrative examples, third shape 232 comprises a parallelogram.

In some illustrative examples, third shape 232 has a portion overlapping a portion of second shape 225 and a portion of first shape 220 within each pre-kitted ply set of plurality of pre-kitted ply sets 206.

To form continuous plies 204, pre-kitted ply set 210 is positioned to abut pre-kitted ply set 208. In this illustrative example, first ply 234 is positioned to abut first ply 218. Second ply 240 is positioned to abut second ply 224. Third ply 244 is positioned to abut third ply 230. A portion of second ply 240 overlaps a portion of first ply 234 to form overlap 238. A portion of third ply 244 overlaps both second ply 240 and first ply 234. First ply 218 and first ply 234 form a first continuous ply having first ply angle 219. Second ply 224 and second ply 240 form a second continuous ply having second ply angle 226. Third ply 230 and third ply 244 form a third continuous ply having third ply angle 231.

In this illustrative example, composite structure 202 further comprises pre-kitted ply end set 212 abutting one pre-kitted ply set of plurality of pre-kitted ply sets 206. Pre-kitted ply end set 212 comprises first ply 248 having fourth shape 250. First ply of plurality of pre-kitted ply sets 206 and the first ply of pre-kitted ply end set 212 comprise the same ply angle, first ply angle 219. In this illustrative example, pre-kitted ply end set 212 has ply layup 216. Ply layup 216 comprises first ply 248 and third ply 256. Third ply 256 has fifth shape 258 and third ply angle 231. First ply 248 has overhang 252. Third ply 256 has overlap 254 over first ply 248. Pre-kitted ply end set 212 creates a desired shape for an end of continuous plies 204.

In some illustrative examples, an additional plurality of pre-kitted ply sets (not depicted) with a same ply layup as plurality of pre-kitted ply sets 206, ply layup 214, is present. In some illustrative examples, the additional plurality of pre-kitted ply sets is positioned adjacent to plurality of pre-kitted ply sets 206 to extend continuous plies 204.

In some illustrative examples, composite structure 202 further comprises second set of continuous plies 262. Second set of continuous plies 262 is formed by second plurality of pre-kitted ply sets 264. Second plurality of pre-kitted ply sets 264 have a same ply layup, second ply layup 266.

In some illustrative examples, composite structure 202 further comprises zero degree ply 260 positioned over an intersection region of two pre-kitted ply sets of plurality of pre-kitted ply sets 206. For example, zero degree ply 260 may be positioned over an intersection region of pre-kitted ply set 208 and pre-kitted ply set 210.

In some illustrative examples, composite structure 202 further comprises second plurality of pre-kitted ply sets 264 with second ply layup 266 positioned to form second set of continuous plies 262 over plurality of pre-kitted ply sets 206. In some illustrative examples, each pre-kitted ply set of second plurality of pre-kitted ply sets 264 comprises first additional ply 268 having first additional shape 269 and an overhang on a first side of the second ply layup, second ply layup 266. Second plurality of pre-kitted ply sets 264 further comprises second additional ply 270 overlying first additional ply 268, second additional ply 270 having second additional shape 271.

In some illustrative examples, first ply 218, second ply 224, first additional ply 268, and second additional ply 270 each have different respective ply angles.

Composite structure 202 plurality of pre-kitted ply sets 206 is ultrasonically tacked together. In some illustrative examples, composite structure 202 comprises a thermoplastic composite structure 288. In these illustrative examples, thermoplastic composite structure 288 and plurality of pre-kitted ply sets 206 comprise thermoplastic material 284. In some illustrative examples, plurality of pre-kitted ply sets 206 comprises one of thermoset plies 286 or dry fiber plies 285.

Each pre-kitted ply set of plurality of pre-kitted ply sets 206 is pre-consolidated and pre-formed into a desired out of plane curvature. In these illustrative examples, in processing pre-kitted ply set 206, first ply 218 and second ply 224 are laid up lay-up tool 280 in lay-up 272. Afterwards, curvature 294 is pre-formed into first ply 218 and second ply 224 during pre-forming 292. Curvature 294 is specific to pre-kitted ply set 208 and its desired location in composite structure 202. Curvature 294 is out of plane for the plies of composite structure 202. Curvature 294 may also be referred to as an out of plane curvature or an out of plane shape. Curvature 294 is based on a desired location for pre-kitted ply set 208 on consolidation tool 282 for composite structure 202. In some illustrative examples, curvature 294 is a near net shape.

Pre-kitted ply set 208 is pre-consolidated prior to placement on consolidation tool 282. Pre-consolidating 290 first ply 218 and second ply 224 reduces the pressure for consolidating plurality of pre-kitted ply sets to form composite structure 202 on consolidation tool 282.

In some illustrative examples, composite structure 202 is thermoplastic composite structure 288, and each pre-kitted ply set of plurality of pre-kitted ply sets 206 further comprises at least one low temperature thermoplastic material on an outside of the pre-kitted ply set and in contact with at least one of the first ply or the second ply. For example, low temperature thermoplastic material 296 is present in pre-kitted ply set 208. Low temperature thermoplastic material 296 can be on an outside of pre-kitted ply set 208 and in contact with at least one of first ply 218 or second ply 224. Low temperature thermoplastic material 296 can add in reducing the energy for temperature and pressure applied to consolidating composite structure 202 on consolidation tool 282.

The illustration of manufacturing environment 200 in FIGS. 2A and 2B is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, other quantities of plies can be present in plurality of pre-kitted ply sets 206. In another illustrative example, ply layup 214 can include only two plies. In some illustrative examples, ply layup 214 can include four plies.

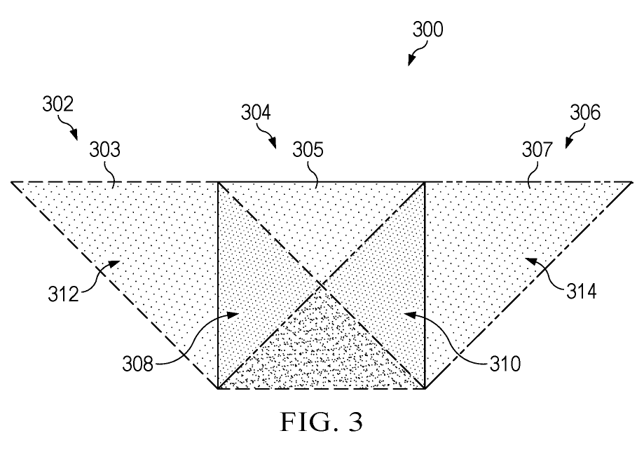

Turning now to FIG. 3, an illustration of a top view of a pre-kitted ply set is depicted in accordance with an illustrative embodiment. Pre-kitted ply set 300 is a physical implementation of pre-kitted ply set 208 of FIGS. 2A and 2B.

In some illustrative examples, pre-kitted ply set 300 has been heated, formed, and consolidated. By being pre-consolidated and formed, layup time on a large consolidation tool for the structure is reduced.

First ply 302 has first shape 303. In this illustrative example, first shape 303 comprises a parallelogram. In this illustrative example, the parallelogram has a top acute angle to the left. First ply 302 has any desirable first ply angle. In some illustrative examples, the first ply angle is selected from at least one of 30 degrees, +45 degrees, 60 degrees, -45 degrees, or 90 degrees. In some illustrative examples, the first ply angle is -45 degrees.

Second ply 304 has second shape 305. In this illustrative example, second shape 305 comprises a square. In this illustrative example, part of second ply 304 is positioned beneath a portion of first ply 302, resulting in overlap 308. Second ply 304 has any desirable second ply angle different from the first ply angle. In some illustrative examples, the second ply angle is selected from at least one of 30 degrees, +45 degrees, 60 degrees, -45 degrees, or 90 degrees. In some illustrative examples, the second ply angle is 90 degrees.

Third ply 306 has third shape 307. In this illustrative example, third shape 307 comprises a parallelogram. In this illustrative example, the parallelogram has a top acute angle to the right. In this illustrative example, first shape 303 is a mirror image of third shape 307. In this illustrative example, second ply 304 is positioned above a portion of third ply 306, resulting in overlap 310. Third ply 306 has any desirable third ply angle different from the first ply angle and second ply angle. In some illustrative examples, the third ply angle is selected from at least one of 30 degrees, +45 degrees, 60 degrees, -45 degrees, or 90 degrees. In some illustrative examples, the third ply angle is 45 degrees.

A portion of first ply 302 extends out over second ply 304 resulting in overhang 312. A portion of third ply 306 extends out from under second ply 304 resulting in overhang 314.

First ply 302, second ply 304, and third ply 306 are designed and laid up to allow for assembling pre-kitted ply set 300 side by side with another pre-kitted ply set on a forming tool.

In some illustrative examples, pre-kitted ply set 300 is a preformed and pre-consolidated pack of thermoplastic plies. Pre-kitted ply set 300 can be used as a portion of a large-scale part deposition and consolidation.

In some illustrative examples, the pre-kitted ply set is consolidated in a press. In some illustrative examples, the pre-kitted ply set is vacuum consolidated. In some illustrative examples, the pre-kitted ply set is placed in an envelope bag and consolidated. In some illustrative examples, pressure greater than vacuum can be used, if desired.

Pre-kitted ply set 300 could have been heated in an envelope bag or on an adaptable forming tool or table. The small quantity of plies in pre-kitted ply set 300 allows for minimum pressure forming.

In some illustrative examples, pre-kitted ply set 300 is directly picked and placed to storage. In some illustrative examples, the pre-kitted ply set is picked and placed to a forming machine, such as an adaptive forming table. In some illustrative examples, the pre-kitted ply set is picked and placed as plies without a bag or other handling materials. In some illustrative examples, the pre-kitted ply set is picked and placed while within an envelope bag.

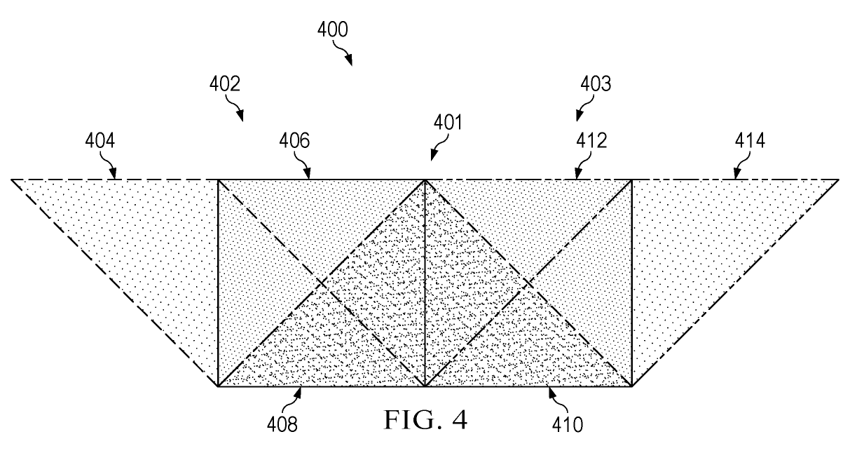

Turning now to FIG. 4, an illustration of a top view of a plurality of pre-kitted ply sets is depicted in accordance with an illustrative embodiment. Pre-kitted ply set 402 is a physical implementation of pre-kitted ply set 208 of FIGS. 2A and 2B. Pre-kitted ply set 403 is a physical implementation of pre-kitted ply set 210 of FIGS. 2A and 2B.

In view 400, plurality of pre-kitted ply sets 401 is depicted. Plurality of pre-kitted ply sets 401 comprises pre-kitted ply set 402 and pre-kitted ply set 403 with a same layup. In this illustrative example, either of pre-kitted ply set 402 and pre-kitted ply set 403 can be the same as pre-kitted ply set 300. Pre-kitted ply set 402 comprises first ply 404, second ply 406, and third ply 408. Pre-kitted ply set 403 comprises first ply 410, second ply 412, and third ply 414.

First ply 404 and first ply 410 have a same first shape. In this illustrative example, the first shape is a parallelogram. First ply 404 and first ply 410 have a same first ply angle. Pre-kitted ply set 403 is positioned such that first ply 410 abuts first ply 404 to form a first layer of material.

Second ply 406 and second ply 412 have a same second shape. In this illustrative example, the second shape is a square. Second ply 406 and second ply 412 have a same second ply angle. Pre-kitted ply set 403 is positioned such that second ply 412 abuts second ply 406 to form a second layer of material.

Third ply 408 and third ply 414 have a same third shape. In this illustrative example, the third shape is a parallelogram. Third ply 408 and third ply 414 have a same third ply angle. Pre-kitted ply set 403 is positioned such that third ply 414 abuts third ply 408 to form a third layer of material.

In some illustrative examples, each of plurality of pre-kitted ply sets 401 is pre-formed to a designated shape prior to placement on a tool. In some illustrative examples, each of plurality of pre-kitted ply sets 401 is pre-formed to a designated shape prior to positioning abutting each other. In some illustrative examples, pre-kitted ply set 402 and pre-kitted ply set 403 are formed to different curvatures.

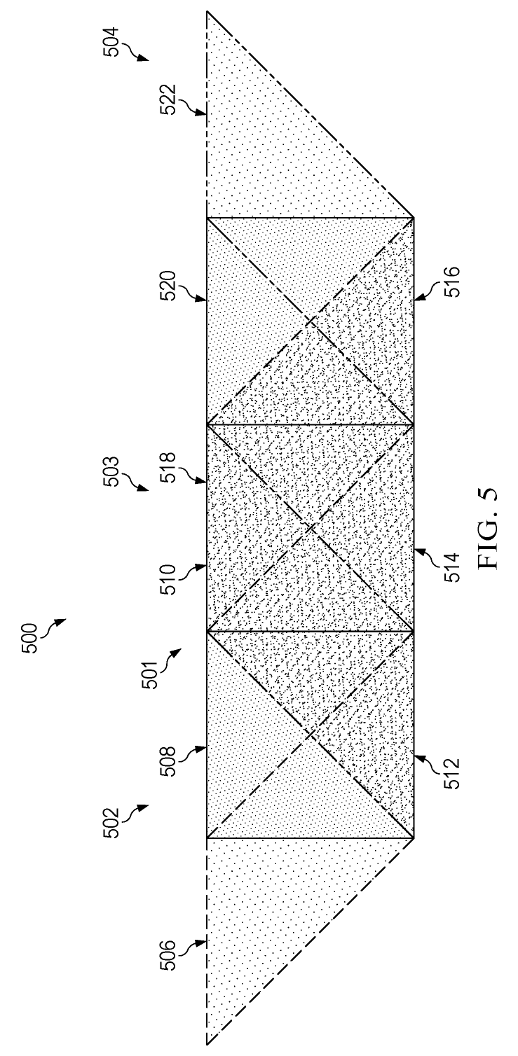

Turning now to FIG. 5, an illustration of a top view of a plurality of pre-kitted ply sets is depicted in accordance with an illustrative embodiment. Plurality of pre-kitted ply sets 501 is a physical implementation of plurality of pre-kitted ply sets 206 of FIGS. 2A and 2B.

In view 500, plurality of pre-kitted ply sets 501 is depicted. Plurality of pre-kitted ply sets 501 comprises pre-kitted ply set 502, pre-kitted ply set 503, and pre-kitted ply set 504 with a same layup. In this illustrative example, any of pre-kitted ply set 502, pre-kitted ply set 503, and pre-kitted ply set 504 can be the same as pre-kitted ply set 300.

Plurality of pre-kitted ply sets 501 is forming continuous plies. First ply 506 of pre-kitted ply set 502, first ply 508 of pre-kitted ply set 503, and first ply 510 of pre-kitted ply set 504 form a first continuous ply. Second ply 512 of pre-kitted ply set 502, second ply 514 of pre-kitted ply set 503, and second ply 516 of pre-kitted ply set 504 form a second continuous ply. Third ply 518 of pre-kitted ply set 502, third ply 520 of pre-kitted ply set 503, and third ply 522 of pre-kitted ply set 504 form a third continuous ply.

First ply 506, first ply 508, and first ply 510 have a same first shape. In this illustrative example, the first shape is a parallelogram. First ply 506, first ply 508, and first ply 510 have a same first ply angle to form the first continuous ply. Pre-kitted ply set 503 is positioned such that first ply 508 abuts first ply 506. Pre-kitted ply set 504 is positioned such that first ply 510 abuts first ply 508.

Second ply 512, second ply 514, and second ply 516 have a same second shape. In this illustrative example, the second shape is a square. Second ply 512, second ply 514, and second ply 516 have a same second ply angle to form the second continuous ply. Pre-kitted ply set 503 is positioned such that second ply 514 abuts second ply 512. Pre-kitted ply set 504 is positioned such that second ply 516 abuts second ply 514.

Third ply 518, third ply 520, and third ply 522 have a same third shape. In this illustrative example, the third shape is a parallelogram. Third ply 518, third ply 520, and third ply 522 have a same third ply angle to form the third continuous ply. Pre-kitted ply set 503 is positioned such that third ply 520 abuts third ply 518. Pre-kitted ply set 504 is positioned such that third ply 522 abuts third ply 520.

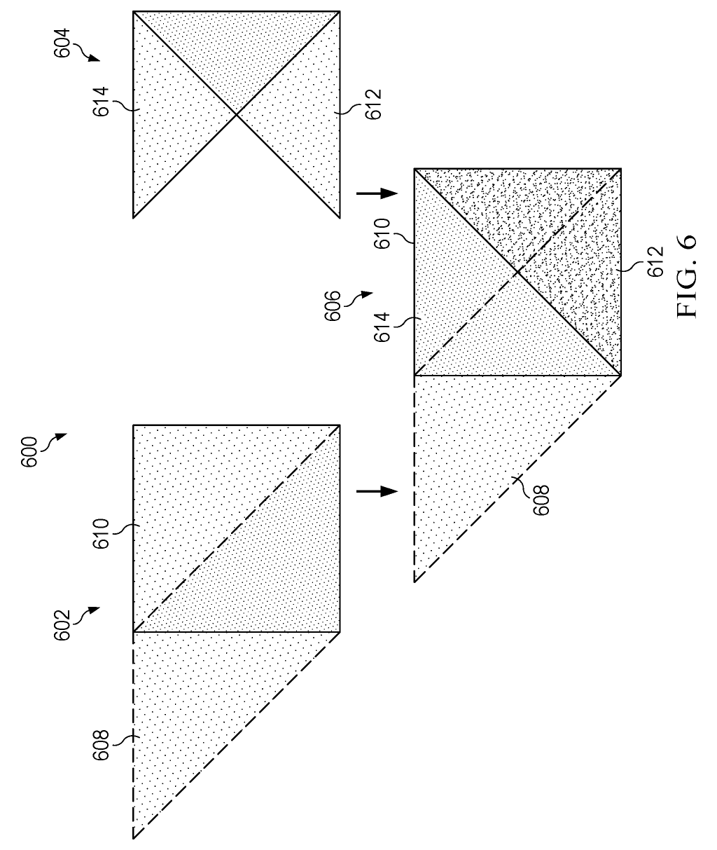

Turning now to FIG. 6, an illustration of a top view of a pre-kitted ply end set is depicted in accordance with an illustrative embodiment. Pre-kitted ply end set 606 is a physical implementation of pre-kitted ply end set 212 of FIGS. 2A and 2B.

Pre-kitted ply end set 606 is formed using four plies. Pre-kitted ply end set 606 is formed by combining plies 602 and plies 604. Plies 602 comprises first ply 608 and second ply 610. In some illustrative examples, first ply 608 has a first shape and first ply angle the same as previously laid up pre-kitted ply sets, such as pre-kitted ply set 300, pre-kitted ply set 402, pre-kitted ply set 403, pre-kitted ply set 502, pre-kitted ply set 503, or pre-kitted ply set 504. In some illustrative examples, second ply 610 has a second shape and second ply angle the same as previously laid up pre-kitted ply sets, such as pre-kitted ply set 300, pre-kitted ply set 402, pre-kitted ply set 403, pre-kitted ply set 502, pre-kitted ply set 503, or pre-kitted ply set 504.

Plies 604 comprises first ply 614 and third ply 612. First ply 614 has fourth shape and first ply angle. First ply 614 abuts a previous first ply with the first ply angle. In this illustrative example, first ply 614 abuts first ply 608 in pre-kitted ply end set 606. Fourth shape of first ply 614 creates a neat ply edge. Although fourth shape comprises ninety degree angles to create a neat ply edge, the fourth shape can comprise any desirable shape.

Third ply 612 has a fifth shape and third ply angle. Third ply 612 will abut a previous third ply with the third ply angle. Fifth shape of third ply 612 creates a neat ply edge. Although fifth shape comprises ninety degree angles to create a neat ply edge, the fifth shape can comprise any desirable shape.

Plies 602 and plies 604 are combined to form pre-kitted ply end set 606. Pre-kitted ply end set 606 can be placed to abut a pre-kitted ply set such as one of pre-kitted ply set 300, pre-kitted ply set 402, pre-kitted ply set 403, pre-kitted ply set 502, pre-kitted ply set 503, or pre-kitted ply set 504.

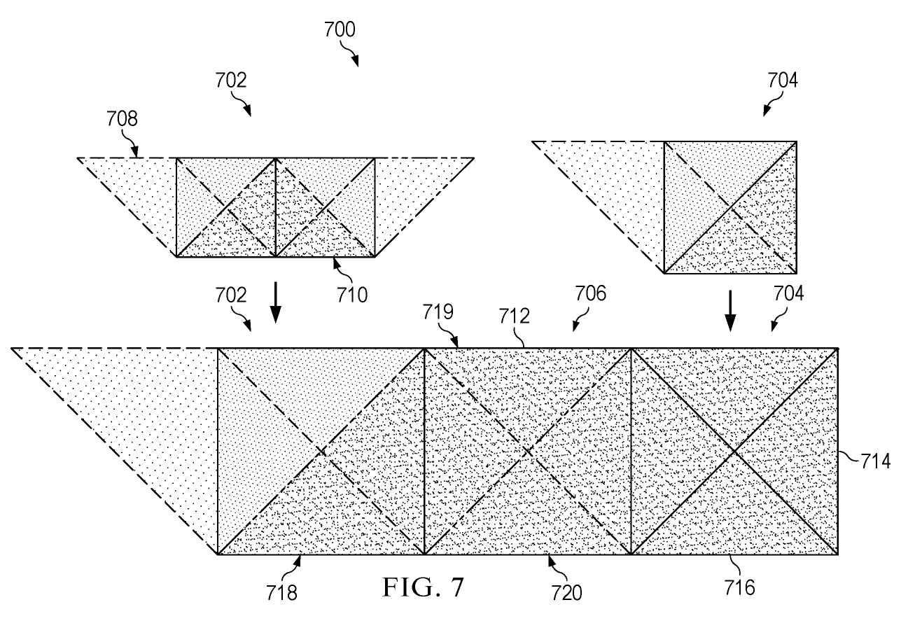

Turning now to FIG. 7, an illustration of a top view of a plurality of pre-kitted ply sets and a pre-kitted ply end set is depicted in accordance with an illustrative embodiment. In view 700, plurality of pre-kitted ply sets 702 is combined with pre-kitted ply end set 704 to form composite layup 706. Plurality of pre-kitted ply sets 702 comprises pre-kitted ply set 708 and pre-kitted ply set 710. Pre-kitted ply set 708 and pre-kitted ply set 710 have the same layup. Pre-kitted ply end set 704 is configured to provide neat edges for each ply of pre-kitted ply set 710.

Composite layup 706 comprises first continuous ply 718, second continuous ply 719, and third continuous ply 720. The combination of pre-kitted ply set 708, pre-kitted ply set 710, and pre-kitted ply end set 704 form edge 712, edge 714, and edge 716. Each of edge 712, edge 714, and edge 716 can have any desirable shape. In some illustrative examples, additional pre-kitted ply sets can be laid up to abut at least one of edge 712 or edge 716.

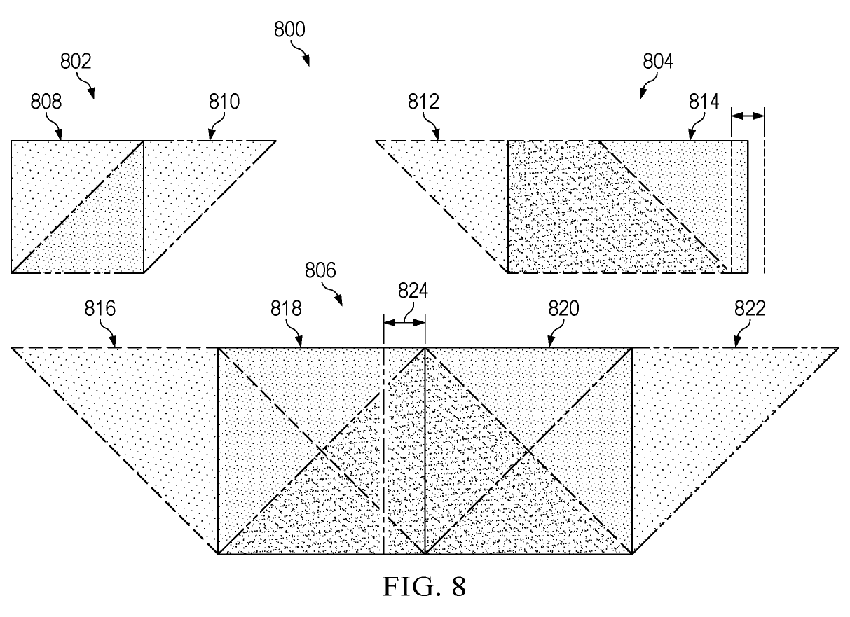

Turning now to FIG. 8, an illustration of a top view of a plurality of pre-kitted ply sets and a second plurality of pre-kitted ply sets is depicted in accordance with an illustrative embodiment. In view 800, multiple instances of pre-kitted ply set design 802 and pre-kitted ply set design 804 are combined to form plurality of pre-kitted ply sets 806. Pre-kitted ply set design 802 comprises second ply 808 having second shape and second ply angle and third ply 810 having third shape and third ply angle. Pre-kitted ply set design 804 comprises zero degree ply 814 and first ply 812 having first shape and first ply angle. Plurality of pre-kitted ply sets 806 comprises first pre-kitted ply set 816, second pre-kitted ply set 818, third pre-kitted ply set 820, and second additional pre-kitted ply set 822. First pre-kitted ply set 816 and second pre-kitted ply set 818 have a same design as pre-kitted ply set design 804. By abutting first pre-kitted ply set 816 and second pre-kitted ply set 818, zero degree plies have overlap 824. Third pre-kitted ply set 820 and second additional pre-kitted ply set 822 have a same design as pre-kitted ply set design 802.

In this illustrative example, pre-kitted ply set design 804 can be considered a second plurality of pre-kitted ply sets with a second ply layup positioned to form a second set of continuous plies over the plurality of pre-kitted ply sets. Each pre-kitted ply set of the second plurality of pre-kitted ply sets comprises a first additional ply having a first additional shape and an overhang on a first side of the second ply layup, and a second additional ply overlying the first additional ply, the second additional ply having a second additional shape. In some illustrative examples, first ply 812, second ply 808, third ply 810, and zero degree ply 814 each have a different respective ply angle. In some illustrative examples, the respective ply angles are selected from at least one of 30 degrees, +45 degrees, 60 degrees, -45 degrees, or 90 degrees.

In some illustrative examples, second ply 808 has a second ply angle of 90 degrees. In some illustrative examples, third ply 810 has a third ply angle of 45 degrees. In some illustrative examples, first ply 812 has a first ply angle of -45 degrees.

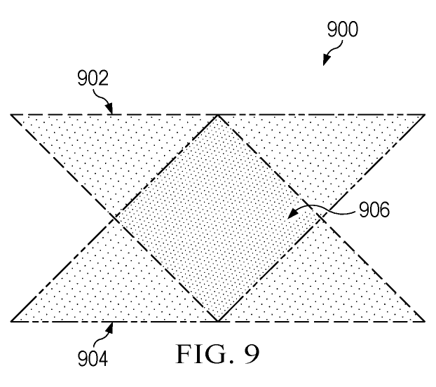

Turning now to FIG. 9, an illustration of a top view of a pre-kitted ply set is depicted in accordance with an illustrative embodiment. Pre-kitted ply set 900 is a physical implementation of pre-kitted ply set 208 of FIGS. 2A and 2B.

In some illustrative examples, pre-kitted ply set 900 has been heated, pre-formed, and pre-consolidated. By being pre-consolidated and formed, layup time on a large consolidation tool for the structure is reduced.

First ply 902 has a first shape and a first ply angle. In this illustrative example, the first shape is a triangle. First ply 902 has any desirable first ply angle. In some illustrative examples, the first ply angle is selected from at least one of 30 degrees, +45 degrees, 60 degrees, -45 degrees, or 90 degrees. In some illustrative examples, the first ply angle is -45 degrees.

Second ply 904 has a second shape. In this illustrative example, the second shape comprises a triangle. In this illustrative example, part of second ply 904 is positioned over a portion of first ply 902, resulting in overlap 906. Second ply 904 has any desirable second ply angle different from the first ply angle. In some illustrative examples, the second ply angle is selected from at least one of 30 degrees, +45 degrees, 60 degrees, -45 degrees, or 90 degrees. In some illustrative examples, the second ply angle is 45 degrees.

Both first ply 902 and second ply 904 have overhangs. Portions of each of first ply 902 and second ply 904 extend out from the other respective ply, resulting in overhangs.

First ply 902 and second ply 904 are designed and laid up to allow for assembling pre-kitted ply set 900 side by side with another pre-kitted ply set on a forming tool.

In some illustrative examples, pre-kitted ply set 900 is a preformed and pre-consolidated pack of thermoplastic plies. Pre-kitted ply set 900 can be used as a portion of a large-scale part deposition and consolidation.

In some illustrative examples, the pre-kitted ply set is consolidated in a press. In some illustrative examples, the pre-kitted ply set is vacuum consolidated. In some illustrative examples, the pre-kitted ply set is placed in an envelope bag and consolidated. In some illustrative examples, pressure greater than vacuum can be used, if desired.

Pre-kitted ply set 900 could have been heated in an envelope bag or on an adaptable forming tool or table. The small quantity of plies in pre-kitted ply set 900 allows for minimum pressure forming.

In some illustrative examples, pre-kitted ply set 900 is directly picked and placed to storage. In some illustrative examples, the pre-kitted ply set is picked and placed to a forming machine, such as an adaptive forming table. In some illustrative examples, the pre-kitted ply set is picked and placed as plies without a bag or other handling materials. In some illustrative examples, the pre-kitted ply set is picked and placed while within an envelope bag.

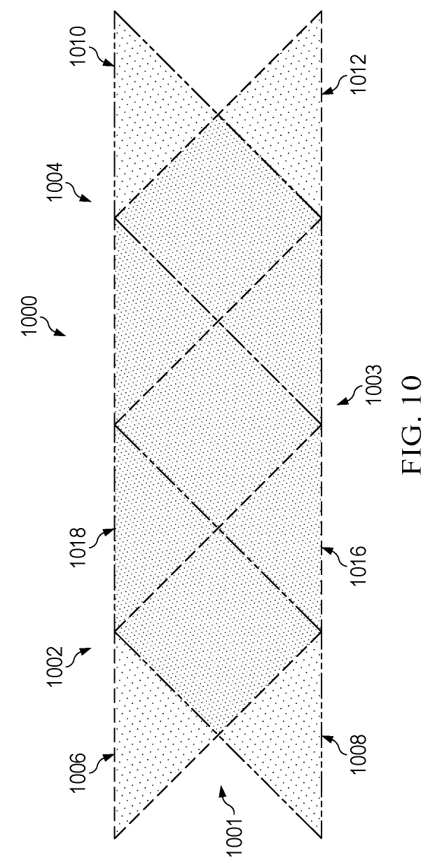

Turning now to FIG. 10, an illustration of a top view of a plurality of pre-kitted ply sets is depicted in accordance with an illustrative embodiment. Pre-kitted ply set 1002 is a physical implementation of pre-kitted ply set 208 of FIGS. 2A and 2B. Pre-kitted ply set 1003 is a physical implementation of pre-kitted ply set 210 of FIGS. 2A and 2B.

In view 1000, plurality of pre-kitted ply sets 1001 is depicted. Plurality of pre-kitted ply sets 1001 comprises pre-kitted ply set 1002 and pre-kitted ply set 1004 with a same layup. In this illustrative example, either of pre-kitted ply set 1002 and pre-kitted ply set 1004 can be the same as pre-kitted ply set 900. Pre-kitted ply set 1002 comprises first ply 1006 and second ply 1008. Pre-kitted ply set 1004 comprises first ply 1010 and second ply 1012. In this illustrative example, pre-kitted ply set 1002 and pre-kitted ply set 1004 have a same orientation.

In this illustrative example, plurality of pre-kitted ply sets 1001 further comprises pre-kitted ply set 1003. Pre-kitted ply set 1003 comprises first ply 1014 and second ply 1016. Pre-kitted ply set 1003 is rotated 180 degrees relative to pre-kitted ply set 1002 and pre-kitted ply set 1004.

First ply 1006, first ply 1010, and first ply 1014 have a same first shape. In this illustrative example, the first shape is a triangle. First ply 1006, first ply 1010, and first ply 1014 have a same first ply angle. Pre-kitted ply set 1003 is positioned such that first ply 1014 abuts first ply 1006 to form a first layer of material.

Second ply 1008, second ply 1012, and second ply 1016 have a same second shape. In this illustrative example, the second shape is a triangle. Second ply 1008, second ply 1012, and second ply 1016 have a same second ply angle. Pre-kitted ply set 1003 is positioned such that second ply 1016 abuts second ply 1008 to form a second layer of material.

In some illustrative examples, each of plurality of pre-kitted ply sets 1001 is pre-formed to a designated shape prior to placement on a tool. In some illustrative examples, each of plurality of pre-kitted ply sets 1001 is pre-formed to a designated shape prior to positioning abutting each other. In some illustrative examples, pre-kitted ply set 1002, pre-kitted ply set 1003, and pre-kitted ply set 1004 are formed to different curvatures.

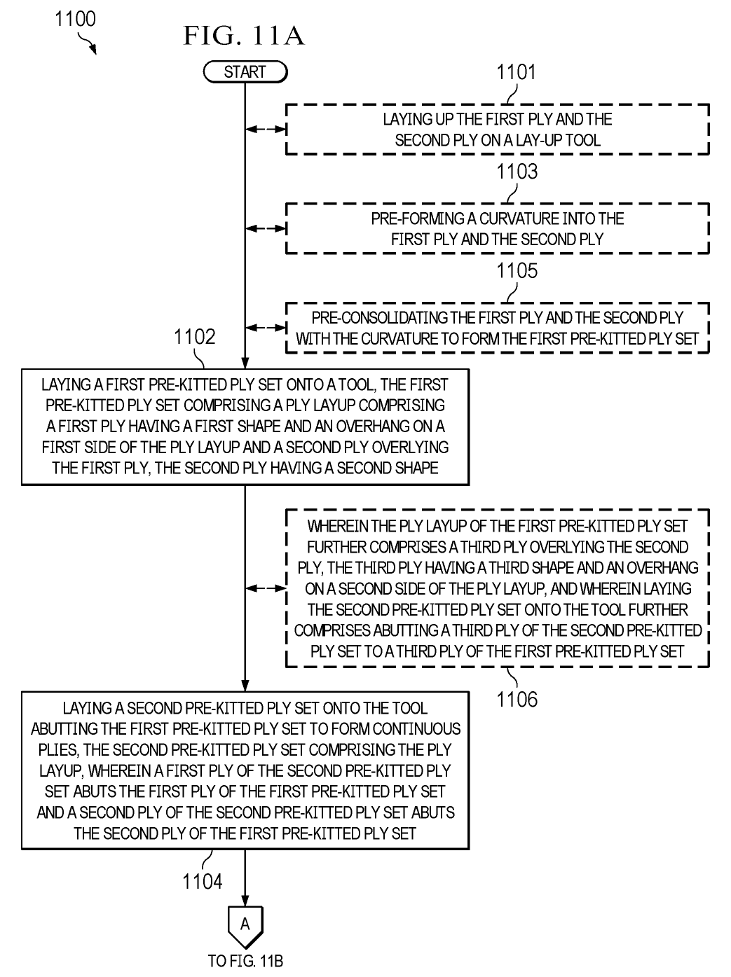

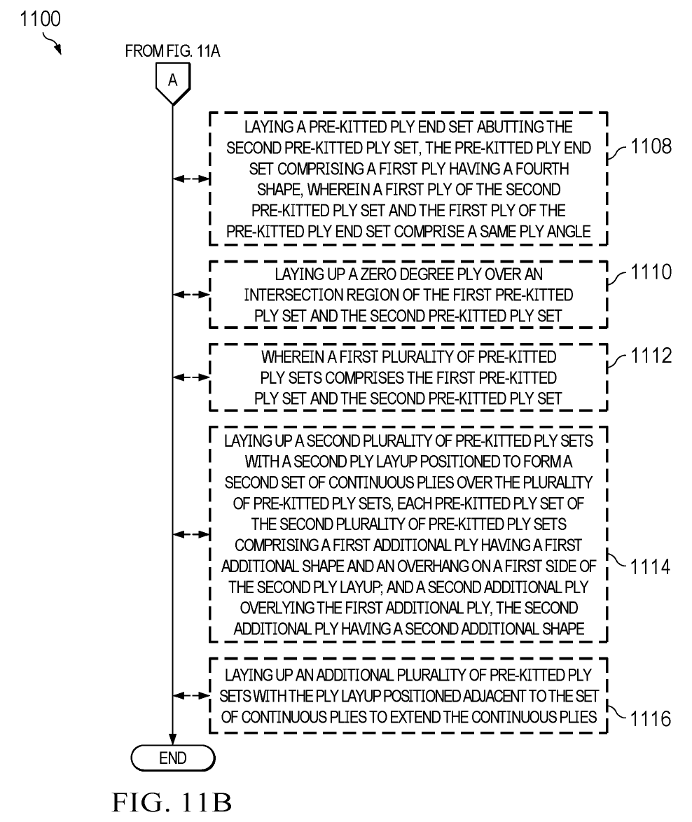

Turning now to FIGS. 11A and 11B, a flowchart of a method of forming a composite structure is depicted in accordance with an illustrative embodiment. Method 1100 can be used to form a composite structure of aircraft 100 of FIG. 1. Method 1100 can be used to form continuous plies 204 of FIGS. 2A and 2B. Pre-kitted ply set 300 of FIG. 3 can be used in method 1100. Pre-kitted ply set 300 can be used in method 1100. Pre-kitted ply set 402 and pre-kitted ply set 403 of FIG. 4 can be used in method 1100. Plurality of pre-kitted ply sets 501 of FIG. 5 can be used in method 1100. Pre-kitted ply end set 606 of FIG. 6 can be used in method 1100. Pre-kitted ply set 702 and pre-kitted ply end set 704 of FIG. 7 can be used in method 1100. Pre-kitted ply set design 802 and pre-kitted ply set design 804 of FIG. 8 can be used in method 1100.

Method 1100 lays a first pre-kitted ply set onto a tool, the first pre-kitted ply set comprising a ply layup comprising a first ply having a first shape and an overhang on a first side of the ply layup and a second ply overlying the first ply, the second ply having a second shape (operation 1102). The first pre-kitted ply set is pre-consolidated. In some illustrative examples, the first pre-kitted ply set is pre-formed to a desired curvature.

Method 1100 lays a second pre-kitted ply set onto the tool abutting the first pre-kitted ply set to form continuous plies, the second pre-kitted ply set comprising the ply layup, wherein a first ply of the second pre-kitted ply set abuts the first ply of the first pre-kitted ply set and a second ply of the second pre-kitted ply set abuts the second ply of the first pre-kitted ply set (operation 1104). Afterwards, method 1100 terminates.

In some illustrative examples, method 1100 lays up the first ply and the second ply on a lay-up tool (operation 1101). In some illustrative examples, method 1100 pre-forms a curvature into the first ply and the second ply (operation 1103). In some illustrative examples, method 1100 pre-consolidates the first ply and the second ply with the curvature to form the first pre-kitted ply set (operation 1105).

In some illustrative examples, the ply layup of the first pre-kitted ply set further comprises a third ply overlying the second ply, the third ply having a third shape and an overhang on a second side of the ply layup, and wherein laying the second pre-kitted ply set onto the tool further comprises abutting a third ply of the second pre-kitted ply set to a third ply of the first pre-kitted ply set (operation 1106).

In some illustrative examples, method 1100 lays a pre-kitted ply end set abutting the second pre-kitted ply set, the pre-kitted ply end set comprising a first ply having a fourth shape, wherein a first ply of the second pre-kitted ply set and the first ply of the pre-kitted ply end set comprise a same ply angle (operation 1108).

In some illustrative examples, method 1100 lays up a zero degree ply over an intersection region of the first pre-kitted ply set and the second pre-kitted ply set (operation 1110).

In some illustrative examples, a plurality of pre-kitted ply sets comprises the first pre-kitted ply set and the second pre-kitted ply set (operation 1112). In some illustrative examples, method 1100 lays up a second plurality of pre-kitted ply sets with a second ply layup positioned to form a second set of continuous plies over the plurality of pre-kitted ply sets, each pre-kitted ply set of the second plurality of pre-kitted ply sets comprising: a first additional ply having a first additional shape and an overhang on a first side of the second ply layup; and a second additional ply overlying the first additional ply, the second additional ply having a second additional shape (operation 1114).

In some illustrative examples, the plurality of pre-kitted ply sets comprises the first pre-kitted ply set and the second pre-kitted ply set. In some illustrative examples, method 1100 lays up an additional plurality of pre-kitted ply sets with the ply layup positioned adjacent to the set of continuous plies to extend the continuous plies (operation 1116).

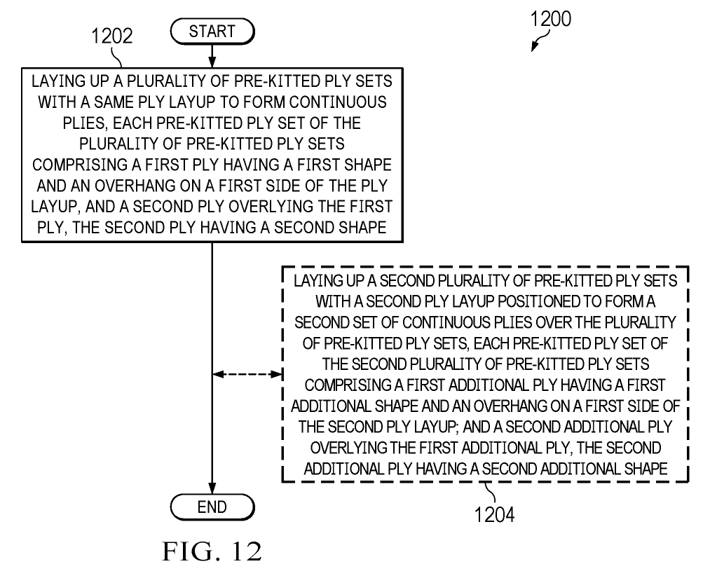

Turning now to FIG. 12, a flowchart of a method of forming a composite structure is depicted in accordance with an illustrative embodiment. Method 1200 can be used to form a composite structure of aircraft 120 of FIG. 1. Method 1200 can be used to form continuous plies 204 of FIGS. 2A and 2B. Pre-kitted ply set 300 of FIG. 3 can be used in method 1200. Pre-kitted ply set 402 and pre-kitted ply set 403 of FIG. 4 can be used in method 1200. Plurality of pre-kitted ply sets 501 of FIG. 5 can be used in method 1200. Pre-kitted ply end set 606 of FIG. 6 can be used in method 1200. Pre-kitted ply set 702 and pre-kitted ply end set 704 of FIG. 7 can be used in method 1200. Pre-kitted ply set design 802 and pre-kitted ply set design 804 of FIG. 8 can be used in method 1200.

Method 1200 lays up a plurality of pre-kitted ply sets with a same ply layup to form continuous plies, each pre-kitted ply set of the plurality of pre-kitted ply sets comprising a first ply having a first shape and an overhang on a first side of the ply layup, and a second ply overlying the first ply, the second ply having a second shape (operation 1202). Afterwards, method 1200 terminates.

In some illustrative examples, method 1200 lays up a second plurality of pre-kitted ply sets with a second ply layup positioned to form a second set of continuous plies over the plurality of pre-kitted ply sets, each pre-kitted ply set of the second plurality of pre-kitted ply sets comprising a third ply having a third shape and an overhang on a first side of the second ply layup; and a second additional ply overlying the third ply, the second additional ply having a second additional shape (operation 1204). In these illustrative examples, the second plurality of pre-kitted ply sets can be considered to be on top of the plurality of pre-kitted ply sets through the thickness of the layup.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, any of operation 1106 through operation 1116 may be optional. As another example, operation 1204 may be optional.

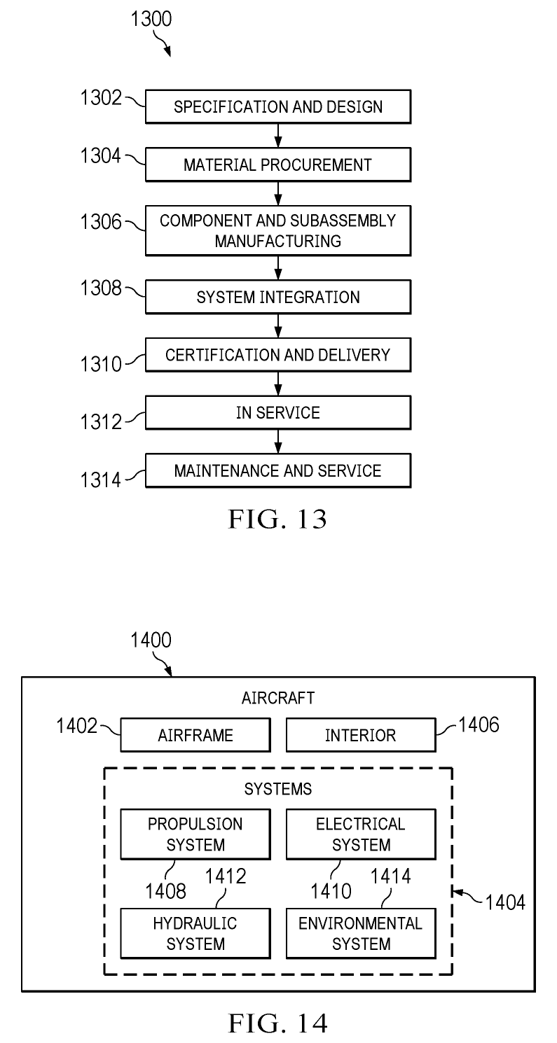

Illustrative embodiments of the present disclosure may be described in the context of aircraft manufacturing and service method 1300 as shown in FIG. 13 and aircraft 1400 as shown in FIG. 14. Turning first to FIG. 13, an illustration of an aircraft manufacturing and service method in a form of a block diagram is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 takes place. Thereafter, aircraft 1400 may go through certification and delivery 1310 in order to be placed in service 1312. While in service 1312 by a customer, aircraft 1400 is scheduled for routine maintenance and service 1314, which may include modification, reconfiguration, refurbishment, or other maintenance and service.

Each of the processes of aircraft manufacturing and service method 1300 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of an aircraft in a form of a block diagram is depicted in which an illustrative embodiment may be implemented. In this example, aircraft 1400 is produced by aircraft manufacturing and service method 1300 of FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included.

Apparatuses and methods embodied herein may be employed during at least one of the stages of aircraft manufacturing and service method 1300. One or more illustrative embodiments may be manufactured or used during at least one of component and subassembly manufacturing 1306, system integration 1308, in service 1312, or maintenance and service 1314 of FIG. 13.

The illustrative examples are directed to building up pre-formed and pre-consolidated packs of thermoplastic plies (offline) to enable feeder lines for large-scale part deposition and consolidation. The illustrative examples provide methods of laying up packs of multiple plies, consolidating and storing as a pre-kit format. In some illustrative examples, at least one method comprises laying +45/90/45 plies (or any off-axis plies) as a pack of three, consolidating and storing as pre-kit format.

In the illustrative examples, to form a large-scale part, the pre-kitted plies are placed on a tool or mandrel. In some illustrative examples, to form a large-scale part, the pre-kitted plies are placed on a flexible forming machine, tacked by ultrasonics and consolidated to shape by applying a bag, heat, and pressure to consolidate into a large-scale component or part.

Pre-kitted plies are placed on a flexible forming machine for consolidation into large scale structure. To create a pre-kitted ply set, a plurality of plies is flat laid up as a pack. In some illustrative examples, +45/90/45 plies (or any other desirable off-axis plies) are laid down as a pack of three.

In some illustrative examples, the pre-kitted ply set is consolidated. In some illustrative examples, the pre-kitted ply set is consolidated in a press. In some illustrative examples, the pre-kitted ply set is vacuum consolidated. In some illustrative examples, the pre-kitted ply set is placed in an envelope bag and consolidated. In some illustrative examples, pressure greater than vacuum can be used, if desired.

In some illustrative examples, the pre-kitted ply set is directly picked and placed to store. In some illustrative examples, the pre-kitted ply set is picked and placed to a forming machine, such as an adaptive forming table. In some illustrative examples, the pre-kitted ply set is picked and placed as plies without a bag or other handling materials. In some illustrative examples, the pre-kitted ply set is picked and placed while within an envelope bag. In some illustrative examples, the pre-kitted ply set can be heated in an envelope bag or can be heated directly by a forming table.

The low quantity of plies in the pre-kitted ply set allow for minimum pressure forming. In some illustrative examples, zero degree plies can be kitted separately or can be placed/deposited directly in the final pack. Ply drops or build-ups are kitted in a similar manner to +45/90/45 packs. If smaller than a second ply planform, zero degree ply plies can be included.

The pre-kitted ply set can be picked from storage and placed on a full consolidation tool. In some illustrative examples, zero degree plies can be deposited as desired. The illustrative examples may splice zero degree ply plies, if allowed, to reduce scale and allow for offline feeder lines.

In some illustrative examples, the heat/pressure may be reduced with the use of low-melt film. In some illustrative examples, the pre-kit format provides for reduced pressure of consolidation.

Pre-kitting thermoplastic packs as in the illustrative examples allows prefabrication on a small scale (smaller scale infrastructure) to enable large scale part production and reduces the amount of monumental equipment. In some illustrative examples, pre-kitting comprises pre-kitting small ply quantities to allow for prefabrication at lower pressures. In some illustrative examples, pre-kitting small ply quantities comprises pre-kitting no more than three plies. In some illustrative examples, pre-kitting small ply quantities comprises pre-kitting no more than four plies. Pre-kitting can comprise any desirable quantity of plies. In some illustrative examples, pre-kitting small ply quantities allows for easier forming.

In some illustrative examples, forming using flexible tooling, such as an ADAPA table, is possible because of lower forming pressures and final shape consolidation is conducted in a later step. In some illustrative examples, direct deposition of the plies onto the flexible tooling, such as the ADAPA table, will reduce the use of dedicated lay-up tooling. The flexible tooling, such as an ADAPA, can make small changes for each pre-kitted ply set.

Pick and place of pre-kitted ply sets onto a final consolidation tool reduces deposition time/utilization cycle time of the consolidation tool. The consolidation tool can be the most valuable and expensive tool in the manufacturing environment.

In some illustrative examples, lower consolidation pressure is applied to the final part when the pre-kitted ply sets are preconsolidated. When the pre-kitted ply sets are preconsolidated, the illustrative examples may only consolidate the interfaces between the pre-kitted ply sets (kits). Limited consolidation may lead to lesser infrastructure to cure.

The illustrative examples provide fabrication of smaller-scale kits or preforms offline from the main consolidation tool. The illustrative examples are also using less pressure to “consolidate”. By using pre-kitted ply sets, consolidation activities can be performed at lower part thicknesses (ply quantities).

The illustrative examples can be used for build/fabrication of large-scale thermoplastic components. The illustrative examples may also be used for higher quality fabrication of mid-sized and/or complex thermoplastic parts.

These illustrative examples enable economic and higher quality manufacture of large thermoplastic structures. Thermoplastic structures can be tougher than thermosets and lighter than metallic parts. A direct cost savings of approximately 30-50% for small and mid-sized components could be accomplished. There could also be benefits in environmental factors, as thermoplastic structures/materials can be largely recycled, when compared to thermoset materials.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A composite structure comprising:a plurality of pre-kitted ply sets with a same ply layup positioned to form continuous plies, each pre-kitted ply set of the plurality of pre-kitted ply sets comprising:a first ply having a first shape and an overhang on a first side of the ply layup; anda second ply overlying at least a portion of the first ply, the second ply having a second shape.

2. The composite structure of claim 1, wherein each pre-kitted ply set of the plurality of pre-kitted ply sets is pre-consolidated and pre-formed into a desired out of plane curvature.

3. The composite structure of claim 1, wherein the composite structure is a thermoplastic composite structure, and wherein each pre-kitted ply set of the plurality of pre- kitted ply sets further comprises at least one low temperature thermoplastic material on an outside of the pre-kitted ply set and in contact with at least one of the first ply or the second ply.

4. The composite structure of claim 1, wherein the first ply has a first ply angle different from a second ply angle of the second ply.

5-7. . (canceled)

8. The composite structure of claim 1, wherein each pre-kitted ply set further comprises a third ply overlying the second ply, the third ply having a third shape and an overhang on a second side of the ply layup.

9. The composite structure of claim 8, wherein the third shape comprises a parallelogram.

10. The composite structure of claim 8, wherein the third shape has a portion overlapping a portion of the second shape and a portion of the first shape within each pre-kitted ply set of the plurality of pre-kitted ply sets.

11. The composite structure of claim 1 further comprising:a pre-kitted ply end set abutting one pre-kitted ply set of the plurality of pre-kitted ply sets, the pre-kitted ply end set comprising a first ply having a fourth shape, the first ply of the plurality of pre-kitted ply sets and the first ply of the pre-kitted ply end set comprise the same ply angle.

12. The composite structure of claim 1 further comprising:an additional plurality of pre-kitted ply sets with a same ply layup as the plurality of pre- kitted ply sets, wherein the additional plurality of pre-kitted ply sets is positioned adjacent to the plurality of pre-kitted ply sets to extend the continuous plies.

13. The composite structure of claim 1 further comprising:a zero degree ply positioned over an intersection region of two pre-kitted ply sets of the plurality of pre-kitted ply sets.

14. The composite structure of claim 1 further comprising:a second plurality of pre-kitted ply sets with a second ply layup positioned to form a second set of continuous plies over the plurality of pre-kitted ply sets, each pre-kitted ply set of the second plurality of pre-kitted ply sets comprising:a first additional ply having a first additional shape and an overhang on a first side of the second ply layup; anda second additional ply overlying the first additional ply, the second additional ply having a second additional shape.

15. The composite structure of claim 14, wherein the first ply, second ply, first additional ply, and second additional ply each have different respective ply angles.

16. The composite structure of claim 1, wherein the plurality of pre-kitted ply sets is ultrasonically tacked together.

17. The composite structure of claim 1, wherein the plurality of pre-kitted ply sets comprise one of thermoset plies or dry fiber plies.

18. A method of forming a composite structure comprising:laying a first pre-kitted ply set onto a tool, the first pre-kitted ply set comprising a ply layup comprising a first ply having a first shape and an overhang on a first side of the ply layup and a second ply overlying the first ply, the second ply having a second shape; andlaying a second pre-kitted ply set onto the tool abutting the first pre-kitted ply set to form continuous plies, the second pre-kitted ply set comprising the ply layup, wherein a first ply of the second pre-kitted ply set abuts the first ply of the first pre-kitted ply set and a second ply of the second pre-kitted ply set abuts the second ply of the first pre-kitted ply set.

19. The method of claim 18 further comprising:laying up the first ply and the second ply on a lay-up tool;pre-forming a curvature into the first ply and the second ply; andpre-consolidating the first ply and the second ply with the curvature to form the first pre- kitted ply set.

20. The method of claim 18, wherein the ply layup of the first pre-kitted ply set further comprises a third ply overlying the second ply, the third ply having a third shape and an overhang on a second side of the ply layup, and wherein laying the second pre-kitted ply set onto the tool further comprises abutting a third ply of the second pre-kitted ply set to a third ply of the first pre-kitted ply set.

21-22. . (canceled)

23. The method of claim 18, wherein a plurality of pre-kitted ply sets comprises the first pre-kitted ply set and the second pre-kitted ply set, the method further comprising:
laying up a second plurality of pre-kitted ply sets with a second ply layup positioned to form a second set of continuous plies over the plurality of pre-kitted ply sets, each pre-kitted ply set of the second plurality of pre-kitted ply sets comprising:a first additional ply having a first additional shape and an overhang on a first side of the second ply layup; anda second additional ply overlying the first additional ply, the second additional ply having a second additional shape.

24. The method of claim 18, wherein a plurality of pre-kitted ply sets comprises the first pre-kitted ply set and the second pre-kitted ply set, the method further comprising:laying up an additional plurality of pre-kitted ply sets with the ply layup positioned adjacent to the set of continuous plies to extend the continuous plies.

25. A method of forming a composite structure comprising:laying up a plurality of pre-kitted ply sets with a same ply layup to form continuous plies, each pre-kitted ply set of the plurality of pre-kitted ply sets comprising a first ply having a first shape and an overhang on a first side of the ply layup, and a second ply overlying the first ply, the second ply having a second shape.

26. . (canceled)
